(19) United States
(12) Patent Application Publication
(10) Pub. No.: US 2010/0128070 A1
(43) Pub. Date: May 27, 2010

(54) LIGHTING DEVICE FOR DISPLAY DEVICE AND DISPLAY DEVICE

(75) Inventor: Masahiro Arai, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/598,925

(22) PCT Filed: Dec. 25, 2007
(86) PCT No.: PCT/JP2007/074793

§ 371 Date: Nov. 5, 2009

(30) Foreign Application Priority Data
May 14, 2007 (JP) 2007-128424

(51) Int. Cl. G09G 5/10; G02F 1/13357

(52) U.S. Cl. 345/690; 362/97.2

(57) ABSTRACT

A lighting device for a display device includes a light source and a chassis arranged to cover the light source. The light source includes a high voltage area to be subjected to relatively high voltage, and a low voltage area to be subjected to relatively low voltage. The chassis includes a distance providing mechanism arranged to provide a vertical distance between the chassis and the light source, so that the vertical distance is relatively large at the high voltage area of the light source and relatively small at the low voltage area of the light source.

### BACKGROUND OF THE INVENTION

1. Field of the Invention

The present invention relates to a lighting device for a display device and a display device including the same.

2. Description of the Related Art

In a display device having non-luminous optical elements as typified by a liquid crystal display device, a backlight device is provided on the backside of a display panel such as a liquid crystal panel, so as to illuminate the display panel (as shown in JP-A-2006-66360, for example).

JP-A-2006-66360 discloses a backlight assembly that includes lamps and a housing member for holding the lamps. In the backlight assembly thus including lamps and a housing member for holding the lamps, beat tones may be generated during dimming control of the lamps, due to the second and third harmonics of dimming control frequency.

There are various theories as to how the beat tones are generated. For example, one of the theories suggests involvement of current leakage from the lamps to the housing member. That is, the beat tones may be due to vibration of the housing member caused by leakage current from the lamps.

JP-A-2006-66360 discloses that recessed portions or outwardly bulging portions corresponding to the lamps are formed on the housing member in order to prevent current leakage between the lamps and the housing member. This construction may be partially effective as a measure for beat tones. However, the strength of the housing member, or specifically, the strength against torsional stress may be significantly reduced, because the recessed (or bulging) portions having a constant depth are arranged to extend over the entire bottom surface of the housing member. Further, the recessed portions, thus extending over the entire bottom surface of the housing member, may cause difficulty in mounting of various components at the time of assembly of the device.

### SUMMARY OF THE INVENTION

In view of the foregoing circumstances, preferred embodiments of the present invention provide a lighting device for a display device having a simple construction that prevents or minimizes beat tones generated on a chassis that holds light sources, while maintaining a sufficient strength of the chassis. In addition, preferred embodiments of the present invention provide a high-quality and highly-reliable display device including such an improved lighting device.

A lighting device for a display device, according to a preferred embodiment of the present invention, includes a light source and a chassis arranged to cover the light source, in which the light source includes a high voltage area to be subjected to relatively high voltage and a low voltage area to be subjected to relatively low voltage. The chassis includes a distance providing mechanism arranged to provide the vertical distance between the chassis and the light source, so that the vertical distance is relatively large at the high voltage area of the light source and relatively low at the low voltage area of the light source.

The inventor of the present application has repeatedly considered measures for beat tones, and discovered that provision of a large distance between the high voltage area of the light source and the chassis is significantly effective for eliminating beat tones. This may be due to major reduction of leakage current expressed by “I”, which results from “d” (distance between the light source and the chassis) being actively set to be large at the area where “V” (potential difference between the light source and the chassis) is large, referring to the following formula (1):

I=2πfεCV=2πfε(S/d)V formula (1)

where “I” is the amount of leakage current, “C” is the stray capacitance, “V” is the potential difference between the light source and the chassis, “S” is the area of the chassis, and “d” is the distance between the light source and the chassis.

On the other hand, at the low voltage area of the light source, “V” (potential difference between the light source and the chassis) is sufficiently small in the above formula (1), and therefore the leakage current is originally small. Accordingly, beat tones can be adequately eliminated even if the distance between the light source and the chassis is set to be relatively small.

The distance providing mechanism, which thus provides the distance between the light source and the chassis so that the distance is relatively large at the high voltage area and is relatively small at the low voltage area, enables substantial elimination of beat tones without increasing the thickness of the entire device.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view showing the general construction of a liquid crystal display device according to a preferred embodiment 1 of the present invention.

FIG. 2 is a sectional view of the liquid crystal display device of FIG. 1 along the line A-A.

FIG. 3 is a sectional view of the liquid crystal display device of FIG. 1 along the line B-B.

FIG. 4 is a perspective view showing the general construction of a backlight chassis included in the liquid crystal display device shown in FIG. 1.

FIG. 5 is a sectional view showing the general construction of a modification of the liquid crystal display device according to the preferred embodiment 1 of the present invention.

FIG. 6 is a perspective view showing the general construction of a backlight chassis included in the liquid crystal display device shown in FIG. 5.

FIG. 7 is an exploded perspective view showing the general construction of another modification of the liquid crystal display device according to the preferred embodiment 1 of the present invention.

FIG. 8 is a sectional view of the liquid crystal display device of FIG. 7 along the line B-B.

FIG. 9 is an exploded perspective view showing the general construction of a liquid crystal display device according to a preferred embodiment 2 of the present invention.

FIG. 10 is a sectional view of the liquid crystal display device of FIG. 9 along the line A-A.

FIG. 11 is a sectional view of the liquid crystal display device of FIG. 9 along the line B-B.

FIG. 12 is a perspective view showing the general construction of a backlight chassis included in the liquid crystal display device shown in FIG. 9.

FIG. 13 is a plan view showing the general construction of the backlight chassis.

FIG. 14 is an exploded perspective view showing the general construction of a modification of the liquid crystal display device according to the preferred embodiment 2 of the present invention.

FIG. 15 is a sectional view of the liquid crystal display device of FIG. 14 along the line B-B.

FIG. 16 is a plan view showing the general construction of a backlight chassis included in another modification of the liquid crystal display device according to the preferred embodiment 2 of the present invention.

FIG. 17 is a sectional view showing the general construction of another modification of the liquid crystal display device according to the preferred embodiment 2 of the present invention.

FIG. 18 is an exploded perspective view showing the general construction of a liquid crystal display device according to a preferred embodiment 3 of the present invention.

FIG. 19 is a sectional view of the liquid crystal display device of FIG. 18 along the line A-A.

FIG. 20 is a sectional view of the liquid crystal display device of FIG. 18 along the line B-B.

FIG. 21 is a plan view showing the general construction of a backlight chassis included in the liquid crystal display device shown in FIG. 18.

FIG. 22 is an exploded perspective view showing the general construction of a modification of the liquid crystal display device according to the preferred embodiment 3.

FIG. 23 is a sectional view of the liquid crystal display device of FIG. 22 along the line B-B.

FIG. 24 is a plan view showing the general construction of a backlight chassis included in the liquid crystal display device shown in FIG. 22.

FIG. 25 is a plan view showing the general construction of a backlight chassis included in another modification of the liquid crystal display device according to the preferred embodiment 3 of the present invention.

FIG. 26 is a sectional view showing the general construction of another modification of the liquid crystal display device according to the preferred embodiment 3 of the present invention.

FIG. 27 is a plan view showing the general construction of a backlight chassis included in the liquid crystal display device shown in FIG. 26.

FIG. 28 is an explanatory diagram showing a driving scheme for cold cathode tubes, which is applied to the liquid crystal display device shown in FIG. 1, 9 or 18.

### DETAILED DESCRIPTION OF THE PREFERRED EMBODIMENTS

Hereinafter, preferred embodiments of the present invention will be shown. In the following preferred embodiments, the construction described in a preferred embodiment 1 preferably includes “inclined surfaces arranged to extend over the entire bottom surface of a chassis” as a distance providing mechanism according to the present invention. The construction described in a preferred embodiment 2 preferably includes “groove sections having continuously varying depth and constant width”. The construction described in a preferred embodiment 3 preferably includes “groove sections having continuously varying depth and width”.

### Preferred Embodiment 1

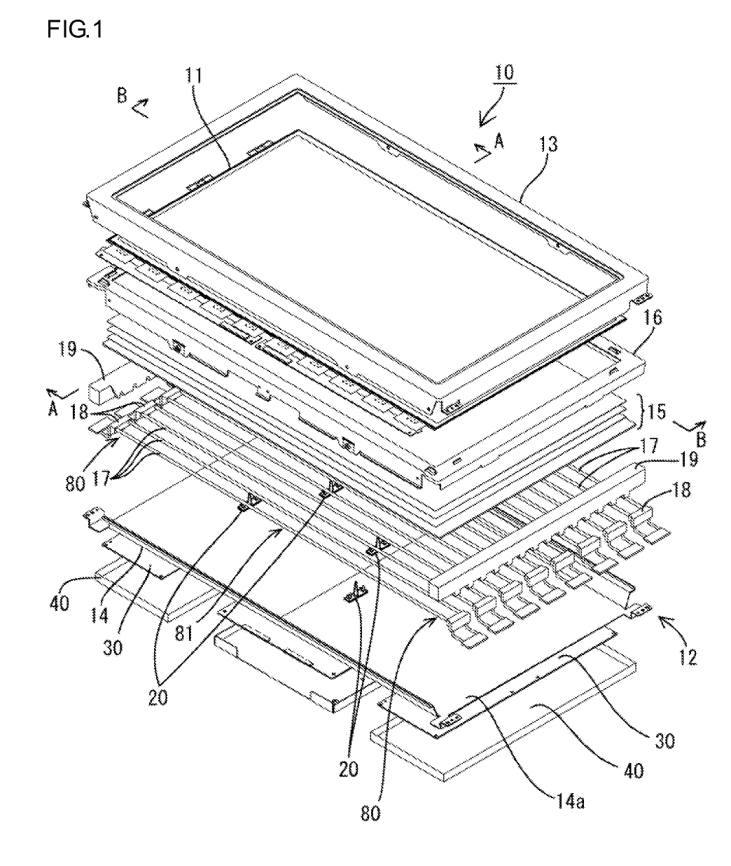

The preferred embodiment 1 of the present invention will be explained with reference to FIGS. 1 to 4.

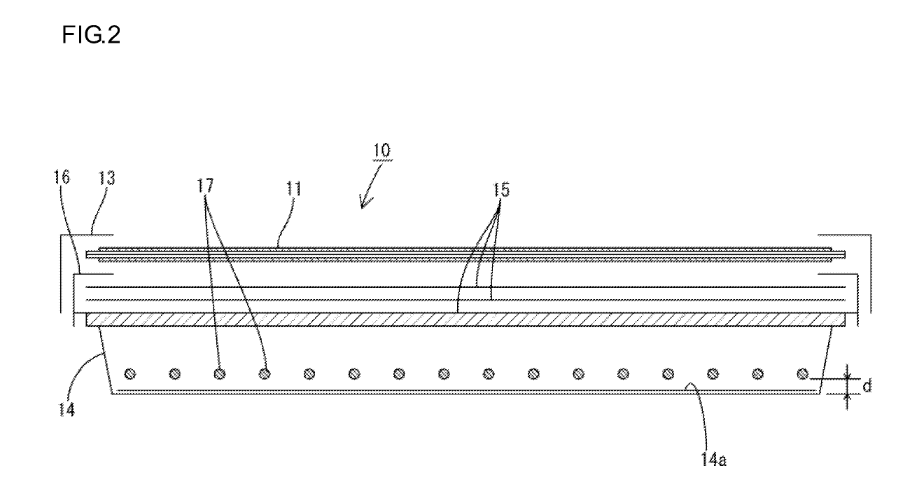

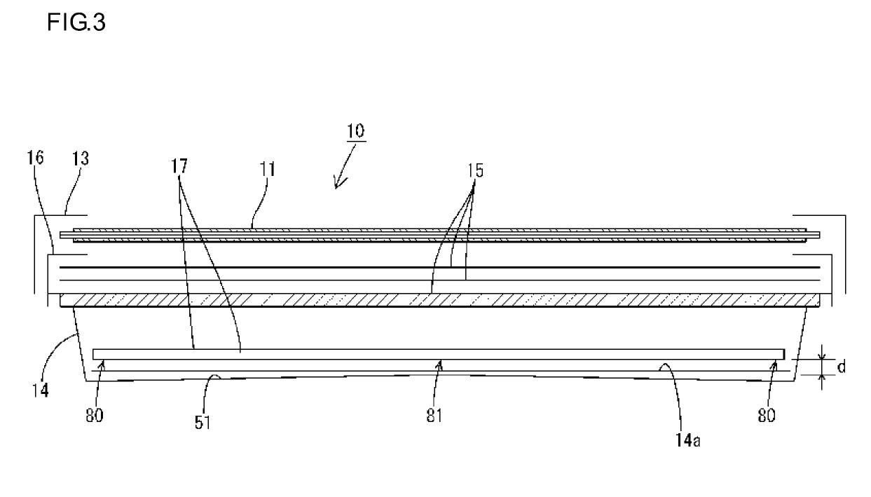

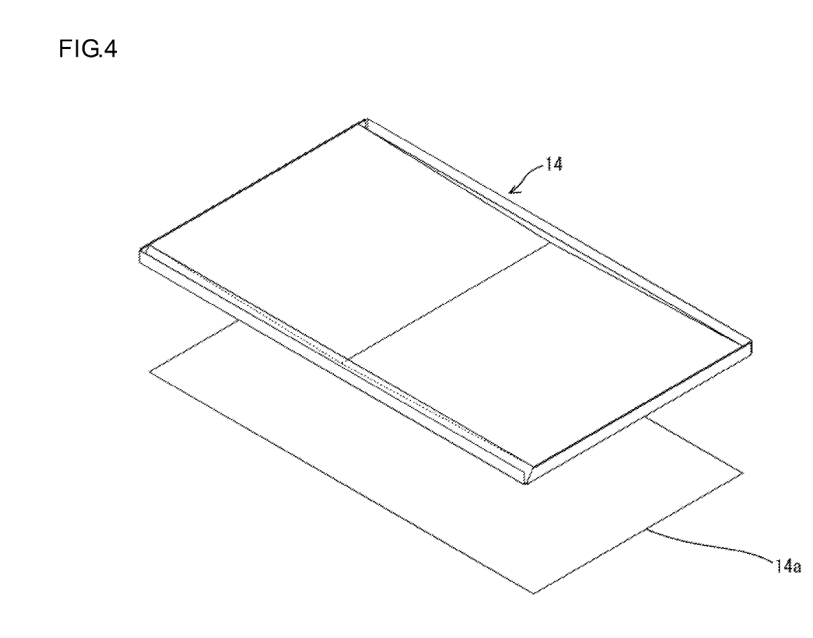

FIG. 1 is an exploded perspective view showing the general construction of a liquid crystal display device according to the present preferred embodiment. FIG. 2 is a sectional view showing the general construction of the liquid crystal display device along the line A-A. FIG. 3 is a sectional view showing the general construction of the liquid crystal display device along the line B-B. FIG. 4 is a perspective view showing the general construction of a backlight chassis (chassis).

The general construction of the liquid crystal display device (display device) 10 according to the present preferred embodiment will be explained first. Referring to FIGS. 1 to 3, the liquid crystal display device 10 includes a liquid crystal panel 11 having a rectangular or substantially rectangular shape, and a backlight device (lighting device for a display device) 12 as an external light source, which are integrally held by a bezel 13 and the like. The liquid crystal panel 11 includes a pair of glass substrates, which are attached to each other so as to face each other while a gap of a predetermined size is kept therebetween. Liquid crystal is sealed between the glass substrates. On one of the glass substrates, components such as switching elements (e.g., TFTs) connected to source wiring lines and gate wiring lines running at right angles to each other, and pixel electrodes connected to the switching elements are provided. On the other of the glass substrates, components such as a counter electrode and a color filter having R, G, and B color sections arranged in a predetermined pattern are provided.

Next, the backlight device 12 will be explained. The backlight device 12 is a so-called direct-light type backlight device that includes a plurality of linear light sources (e.g., cold cathode tubes (light sources) 17 as high-pressure discharge tubes, in the present preferred embodiment), which are positioned directly below the back surface of the liquid crystal panel 11 (i.e., the panel surface on the opposite side of the display side), and are arranged along the panel surface.

The backlight device 12 includes a backlight chassis (chassis) 14 having a substantially box-like shape with an opening on its upper side, and a plurality of optical members 15 (e.g., a diffuser plate, a diffusing sheet, a lens sheet and an optical sheet, in order from the lower side of the figure) which are arranged to cover the opening of the backlight chassis 14. Further included is a frame 16 arranged to hold the optical members 15 on the backlight chassis 14. The backlight chassis 14 contains the cold cathode tubes 17, rubber holders 18 arranged to hold the end portions of the cold cathode tubes 17, lamp holders 19 arranged to collectively cover the cold cathode tubes 17 and the holders 18, and lamp clips 20 arranged to mount and hold the cold cathode tubes 17 on the backlight chassis 14. Note that the optical member 15 side of the cold cathode tubes 17 corresponds to the light emitting side of the backlight device 12.

Each cold cathode tube 17 preferably has an elongated tubular shape, for example. A number (e.g., sixteen in FIG. 1) of cold cathode tubes 17 are contained in the backlight chassis 14 so that the longitudinal direction (or axial direction) thereof corresponds with the long-side direction of the backlight chassis 14. On the other hand, the lamp clips 20, arranged to mount the cold cathode tubes 17 to the backlight chassis 14, function as clip members for holding light sources, and are preferably made of synthetic resin (e.g., polycarbonate).

A light reflecting sheet 14a is provided on the inner surface side (light source side) of the backlight chassis 14, which defines a light reflecting surface. The backlight chassis 14 thus includes the light reflecting sheet 14a, and thereby the light from the cold cathode tubes 17 can be reflected to the optical members 15 such as the diffuser plate (hereinafter, sometimes referred to as “the diffuser plate 15 and the like”). The light reflecting sheet 14a can be preferably formed of a resin sheet having light reflectivity, for example.

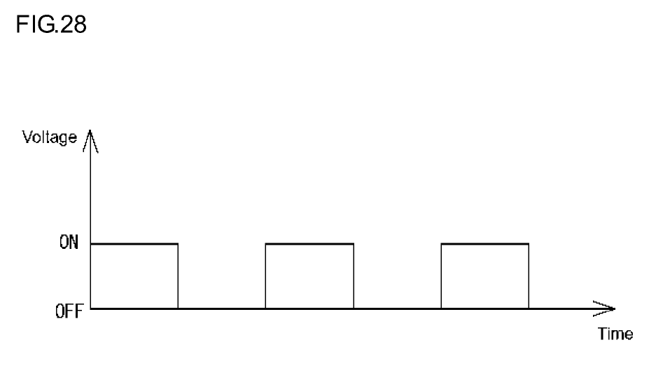

Inverter boards 30 to supply drive voltage to the cold cathode tubes 17 are mounted to the backlight chassis 14, or specifically, mounted on the opposite side of the cold cathode tubes 17 (i.e., on the opposite side of the light emitting surface). Each inverter board 30 includes an inverter circuit that generates a high-frequency voltage for lighting the cold cathode tubes 17. Specifically, in the present preferred embodiment, the inverter circuits are connected to both end portions of each cold cathode tube 17, and therefore the both end portions of the cold cathode tube 17 are subjected to high voltage during lighting. Referring to FIG. 28, in the present preferred embodiment, the cold cathode tubes 17 are preferably driven by pulse-width modulation (PWM), for example. Thereby, the dimming control is performed in a predetermined cycle.

The backlight chassis 14, provided for containing components such as the cold cathode tubes 17 and the light reflecting sheet 14a, is preferably formed of a metallic plate. As shown in FIG. 3, the bottom surface of the backlight chassis 14 has inclined surfaces 51 (an example of a distance providing mechanism), which preferably have an angular shape with a ridge line that extends linearly between the long-sides thereof so as to divide each long-side in half. As a result of this structure, the vertical distance between the cold cathode tubes 17 and (the inclined surfaces 51 of) the backlight chassis 14 is provided to vary along the longitudinal direction of the cold cathode tubes 17 or along the long-side direction of the backlight chassis 14, so that the distance between the central area (or low voltage area) 81 of each cold cathode tube 17 and the central area of the backlight chassis 14 is the smallest while the distance between the end areas (or high voltage areas) 80 of each cold cathode tube 17 and the end areas of the backlight chassis 14 is the largest.

Next, the operational effects of the liquid crystal display device 10 according to the present preferred embodiment will be described. In the liquid crystal display device 10 of the present preferred embodiment, the chassis (backlight chassis) 14 of the backlight device 12 preferably includes inclined surfaces 51 (a example of a distance providing mechanism), so that the vertical distance between the chassis 14 and the cold cathode tubes 17 is relatively large at the high voltage areas 80 of the cold cathode tubes 17, compared to at the low voltage areas 81. According to the construction, beat tones can be prevented while the strength of the chassis 14 is maintained.

The beat tones generated on the chassis 14 are due to vibration of the chassis 14. The vibration may result from various factors, and the factors include current leakage from the cold cathode tubes 17.

The chassis 14 is preferably formed of a conductive metal plate, and therefore a capacitor may be formed between the cold cathode tube 17 and the chassis 14. Accordingly, an ordinary construction (not having inclined surfaces 51) may be prone to current leakage from the cold cathode tubes 17 to the chassis 14. A force acting on the chassis 14 can be generated due to the leakage current, which causes the chassis 14 to vibrate resulting in beat tones. Particularly, in the case of pulse-width modulation, the leakage current can be periodic, and therefore a periodic force acts on the chassis 14 so as to generate beat tones.

In contrast, according to the present preferred embodiment, the chassis 14 of the liquid crystal display device 10 preferably includes inclined surfaces 51, so that the vertical distance between the chassis 14 and the cold cathode tubes 17 is relatively large at the end areas 80 of each cold cathode tube 17 and relatively small at the central area 81. On the other hand, the both end areas of each cold cathode tube 17 are subjected to high voltage while the central area is subjected to low voltage, because the inverter circuits are connected to both end portions of the cold cathode tube 17. That is, the distance between the cold cathode tubes 17 and the chassis 14 is set to be relatively large at the high voltage areas 80 of the cold cathode tubes 17 (or at areas prone to beat tones).

Thereby, the leakage current expressed by “I” can be minimized and prevented resulting in prevention of beat tones, because “d” (distance between the cold cathode tubes 17 and the chassis 14) is sufficiently large in the following formula (1):

I=2πfεCV=2πfε(S/d)V formula (1)

where “I” is the amount of leakage current, “C” is the stray capacitance, “V” is the potential difference between the cold cathode tubes 17 and the chassis 14, “S” is the area of the chassis 14, and “d” is the distance between the cold cathode tubes 17 and the chassis 14.

Further, due to the inclined surfaces 51, the distance between the cold cathode tubes 17 and the chassis 14 is relatively small at the low voltage areas 81 of the cold cathode tubes 17 (or at areas less prone to beat tones). At the low voltage areas of the cold cathode tubes 17, the leakage current is originally small in amount, because “V” (potential difference between the cold cathode tubes 17 and the chassis 14) is sufficiently small in the above formula (1). Therefore, the beat tones can be adequately eliminated even though the distance between the cold cathode tubes 17 and the chassis 14 is relatively small.

Thus, the vertical distance between the high voltage areas 80 of the cold cathode tubes 17 and the chassis 14 is preferably relatively large while the vertical distance between the low voltage areas 81 and the chassis 14 is set to be relatively small, due to provision of the inclined surfaces 51 extending over the entire chassis 14. This construction enables prevention of beat tones without increasing the thickness of the entire backlight device 12 and without reducing the strength thereof.

In the present preferred embodiment, specifically, the inclined surfaces 51 are preferably provided to decrease the vertical distance from the cold cathode tubes 17, continuously and gradually from the high voltage areas 80 of each cold cathode tube 17 toward the low voltage area 81.

Due to the construction thus providing continuously and gradually decreasing distance, beat tones can be effectively eliminated. The high voltage areas 80 are prone to beat tones due to current leakage from the light source. However, the leakage current decreases substantially continuously toward the low voltage area 81. For this reason, the inclined surfaces 51 are provided to decrease the vertical distance between the chassis 14 and the cold cathode tubes 17, continuously from the high voltage areas 80 toward the low voltage areas 81, which is effective to prevent leakage current and thereby prevent beat tones.

Thus, the backlight device 12, and therefore the liquid crystal display device 10 including the backlight device, can have a simple construction including inclined surfaces 51 on the chassis 14, by which the distance between the high voltage areas 80 of each cold cathode tube 17 and the chassis 14 is larger than the distance between the low voltage area 81 and the chassis 14. This construction enables prevention or minimizing of beat tones, while maintaining a sufficient strength of the chassis 14.

Shown above is the preferred embodiment 1 of the present invention. However, the present invention is not limited to the preferred embodiment explained in the above description made with reference to the drawings. The following preferred embodiments may be included in the scope of the present invention, for example.

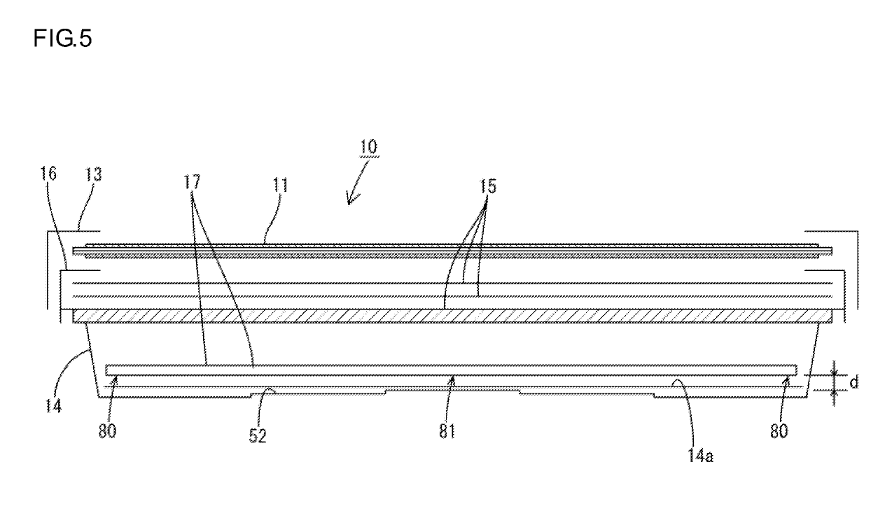

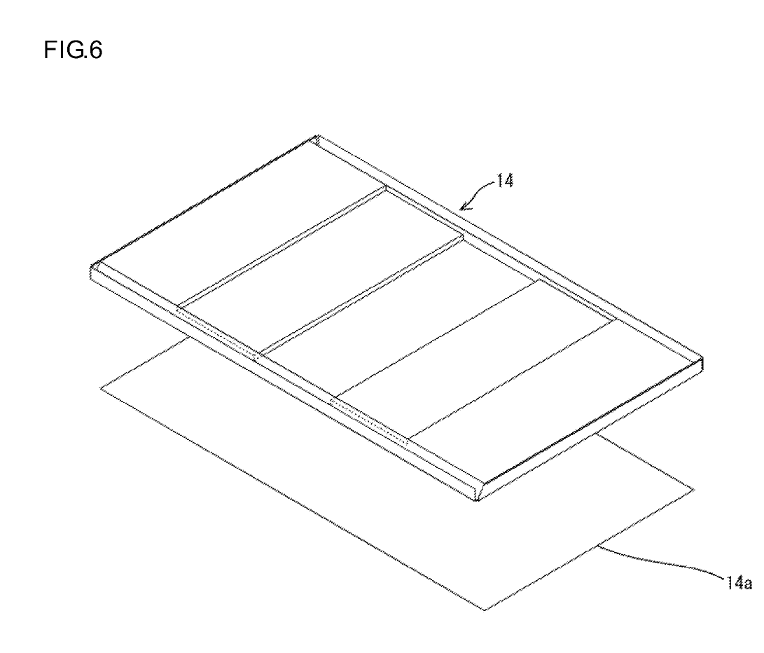

In the above preferred embodiment 1, the inclined surfaces 51 are preferably arranged to decrease the vertical distance between the cold cathode tubes 17 and the backlight chassis 14, continuously and gradually from the high voltage areas 80 of each cold cathode tube 17 toward the low voltage area 81. However, a stepped surface 52 may be provided as shown in FIGS. 5 and 6, so that the distance decreases step-by-step and gradually from the high voltage areas 80 of each cold cathode tube 17 toward the low voltage area 81.

This construction can be provided as an effective measure to prevent beat tones. Further, mounting of various components can be readily and efficiently achieved at the time of assembly of the device, because the respective areas are provided as flat surfaces.

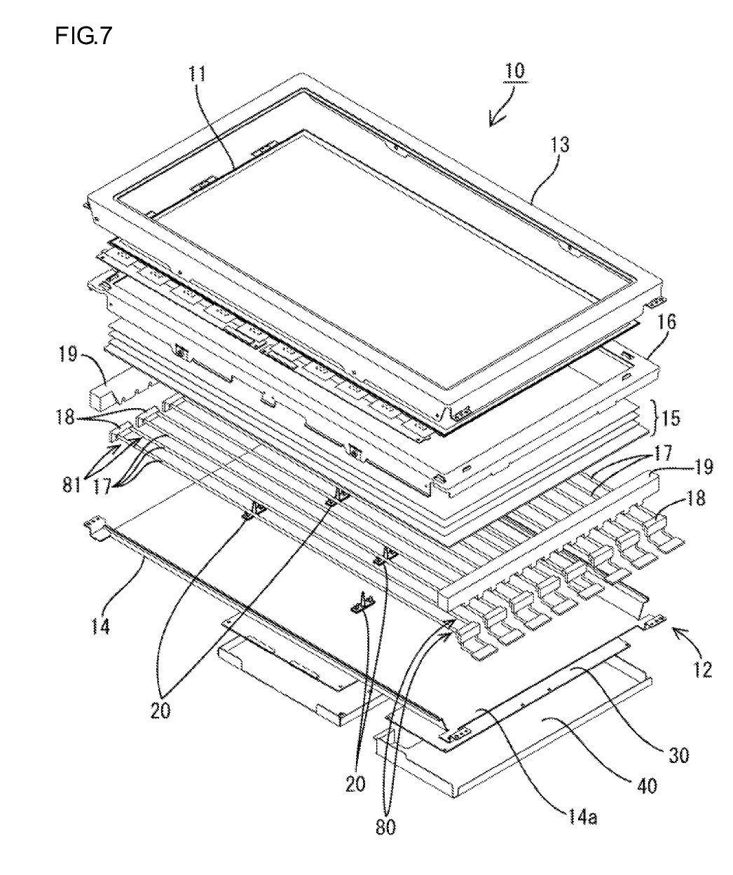

In the above preferred embodiment 1, the inverter boards 30 are provided at two sides of the backlight chassis 14, so that inverter circuits are connected to both end portions of each cold cathode tube 17. However, referring to FIG. 7, an inverter board 30 may be provided at one side of the backlight chassis 14. Further, the cold cathode tubes 17 are not limited to having a linear shape, but rather may be substantially U-shaped cold cathode tubes. In these cases, an inverter circuit is connected to one side of each cold cathode tube 17, and therefore the one side of each cold cathode tube 17 is subjected to high voltage during lighting.

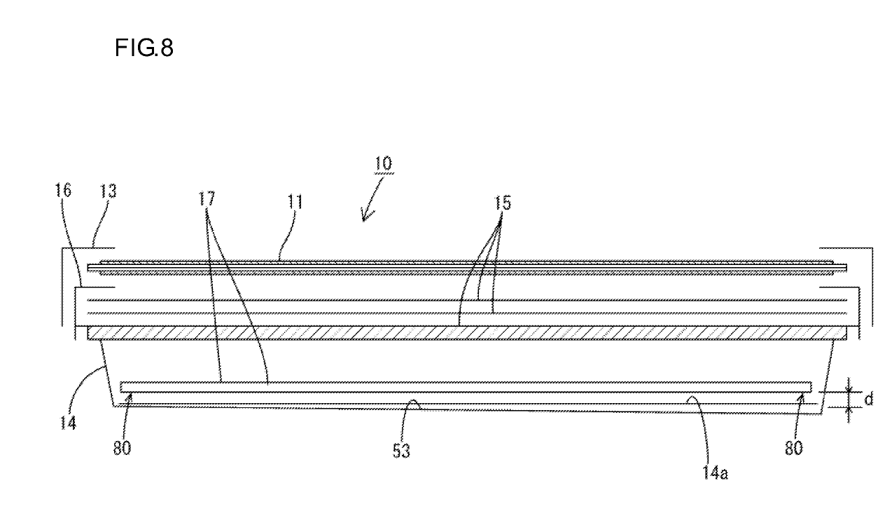

In this construction, referring to FIG. 8, an inclined surface 53 can be arranged to provide the vertical distance between the cold cathode tubes 17 and the inclined surface 53 (of the chassis 14), so that the distance is large at the end side of each cold cathode tube 17 that is connected to the inverter circuit. Preferably, the distance may be arranged to decrease continuously and gradually toward the other end side of each cold cathode tube 17. In the above preferred embodiment 1, the inclined surfaces 51 are preferably flat surfaces. However, the inclined surfaces 51 are not limited to flat surfaces, but rather may be curved surfaces, for example.

### Preferred Embodiment 2

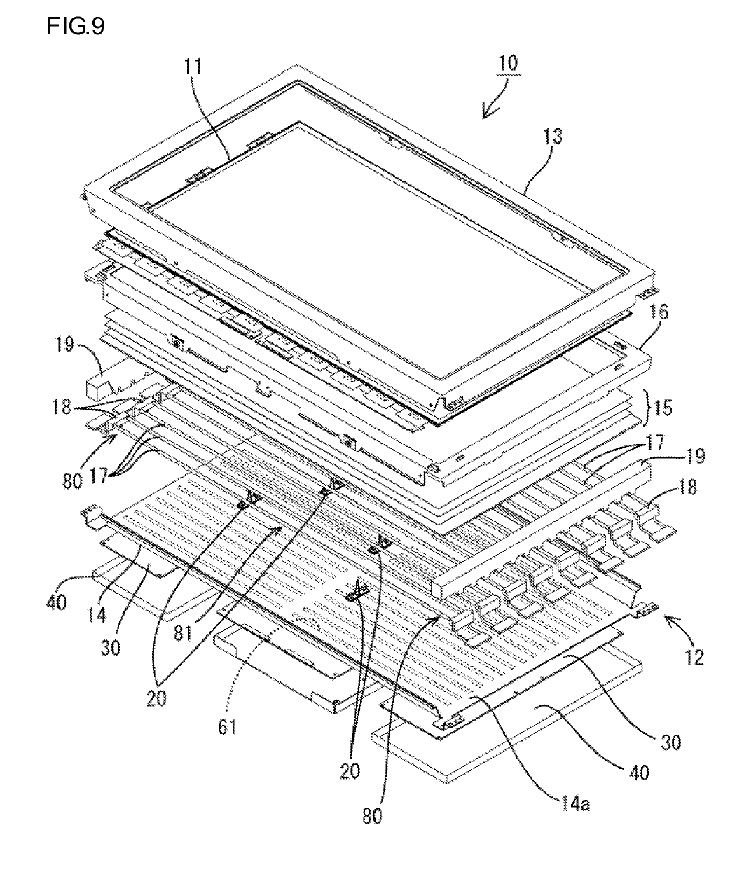

Next, the preferred embodiment 2 of the present invention will be explained with reference to FIGS. 9 to 13. The difference from the above preferred embodiment 1 is that groove sections having continuously varying depth and constant width are provided as the distance providing mechanism, instead of the inclined surfaces arranged to extend over the entire bottom surface of the chassis. The other constructions are similar to the above preferred embodiment. Therefore, the same elements as the above preferred embodiment are designated by the same symbols, and redundant explanations are omitted.

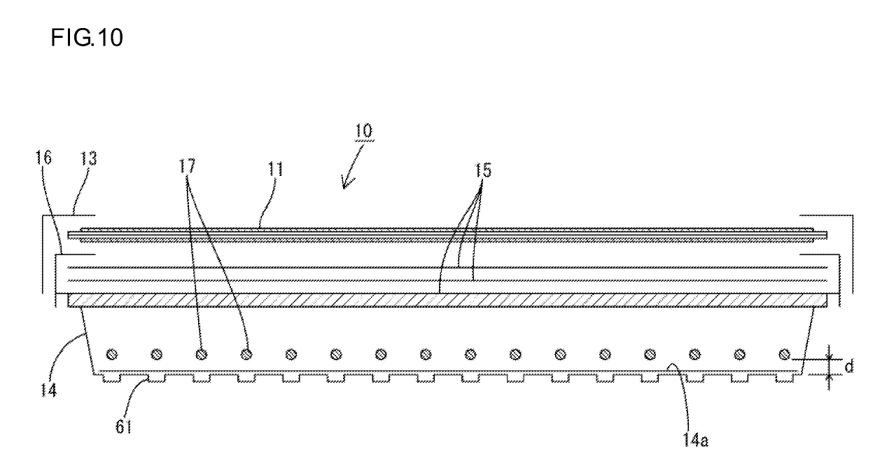

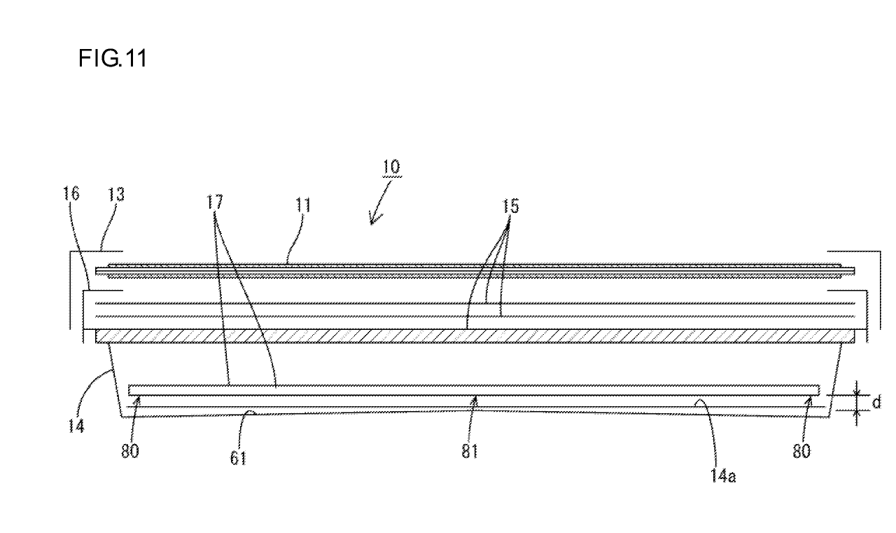

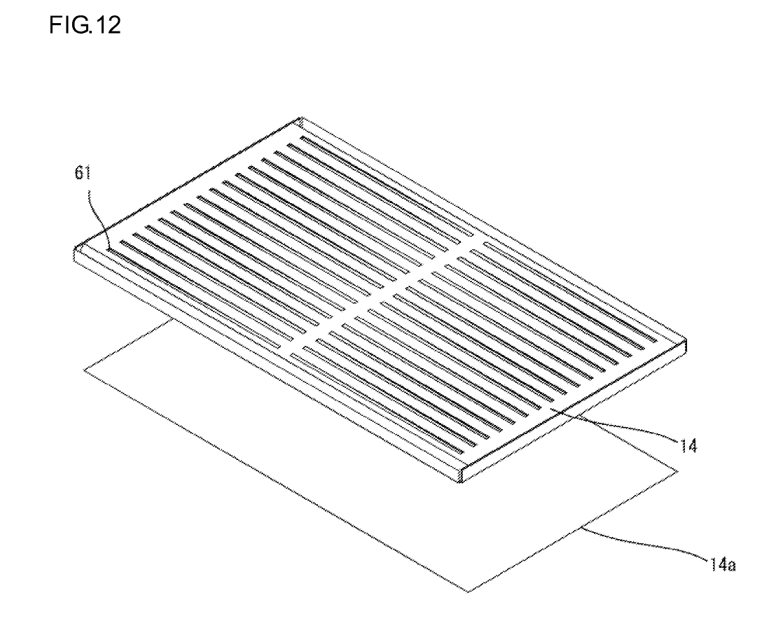

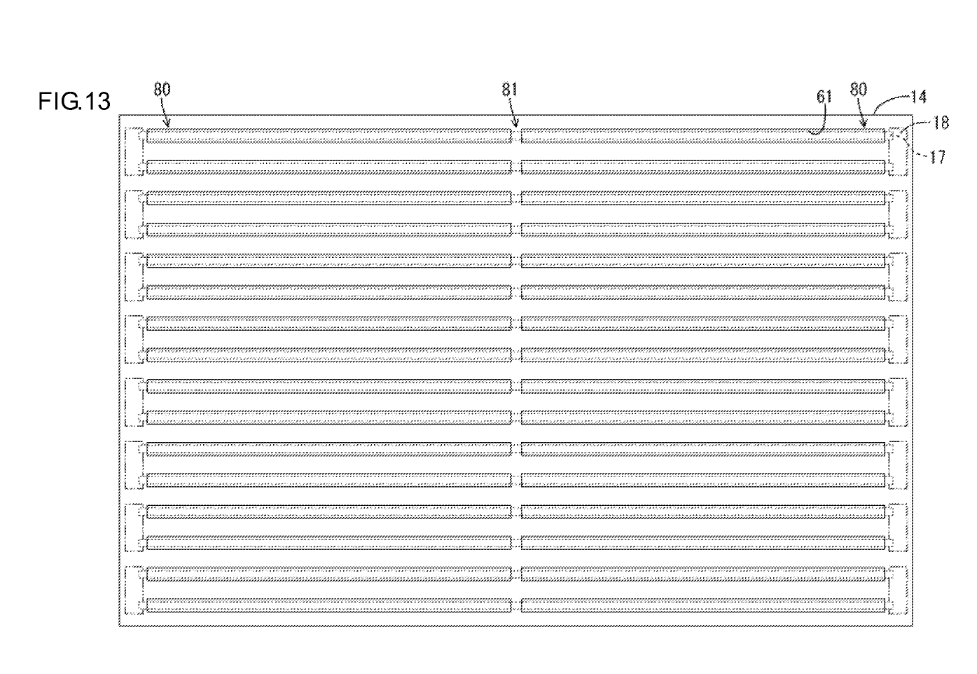

FIG. 9 is an exploded perspective view showing the general construction of a liquid crystal display device according to the present preferred embodiment. FIG. 10 is a sectional view showing the general construction of the liquid crystal display device along the line A-A. FIG. 11 is a sectional view showing the general construction of the liquid crystal display device along the line B-B. FIG. 12 is a perspective view showing the general construction of a backlight chassis (chassis). FIG. 13 is a plan view showing the general construction of the backlight chassis.

Each cold cathode tube 17 preferably has an elongated tubular shape (or a linear shape), and inverter circuits are connected to both end portions thereof (See FIG. 9). Therefore, the both end sides of each cold cathode tube 17 are provided as high voltage areas 80, while the central area is provided as a low voltage area 81. Referring to FIG. 28, in the present preferred embodiment, the cold cathode tubes 17 are driven by pulse-width modulation (PWM), for example. Thereby, the dimming control is performed in a predetermined cycle.

On the other hand, on the bottom surface of the backlight chassis 14 arranged parallel to the cold cathode tubes 17, the groove sections 61 (or distance providing mechanism) are formed to be located directly below the parallel-arranged cold cathode tubes 17. Referring to FIGS. 9 and 13, each groove section 61 is arranged along the axial direction of a cold cathode tube 17, and includes a pair of elongated rectangular sections adjacently arranged along the longitudinal direction thereof so as to face each other.

The groove sections 61 are formed by partly concaving the backlight chassis 14, so as to bulge from the backlight chassis 14 toward the opposite side of the opening side of the groove sections (i.e., toward the opposite side of the light emitting surface) (See. FIG. 10).

Referring to FIG. 11, each groove section 61 preferably has a depth that decreases continuously and gradually from the end areas (or high voltage areas 80) of a cold cathode tube 17 toward the central area (or low voltage area 81).

The groove sections 61 are provided on the inner side of a light reflecting sheet 14a, and therefore are shown by broken lines in FIG. 9. The groove sections 61 are made during the sheet processing of the backlight chassis 14, in the present preferred embodiment.

The liquid crystal display device 10 thus constructed according to the present preferred embodiment can provide the following operational effects.

In the liquid crystal display device 10 of the present preferred embodiment, the chassis (backlight chassis) 14 of the backlight device 12 preferably includes groove sections 61 (or distance providing mechanism), which have a relatively large depth at areas directly below the high voltage areas 80 of the cold cathode tubes 17, and have a relatively small depth at areas directly below the low voltage areas 81. According to the construction, beat tones can be prevented, while the strength of the chassis 14 is maintained.

The beat tones may be generated on the chassis 14 due to vibration of the chassis 14. The vibration may partly result from current leakage from the cold cathode tubes 17. The chassis 14 is preferably formed of a conductive metal plate, and therefore a capacitor may be formed between the cold cathode tube 17 and the chassis 14. Accordingly, an ordinary construction (not including groove sections 61) may be prone to current leakage from the cold cathode tubes 17 to the chassis 14. A force acting on the chassis 14 can be generated due to the leakage current, which causes the chassis 14 to vibrate resulting in beat tones. Particularly, in the case of pulse-width modulation, the leakage current can be periodic, and therefore a periodic force acts on the chassis 14 so as to generate beat tones.

In contrast, according to the present preferred embodiment, the groove sections 61 preferably have a relatively large depth particularly at areas directly below the high voltage areas 80 of the cold cathode tubes 17. Thereby, “d” (distance between the cold cathode tubes 17 and the chassis 14) can be large in the following formula (1):

I=2πfεCV=2πfε(S/d)V formula (1)

where “I” is the amount of leakage current, “C” is the stray capacitance, “V” is the potential difference between the cold cathode tubes 17 and the chassis 14, “S” is the area of the chassis 14, and “d” is the distance between the cold cathode tubes 17 and the chassis 14.

Consequently, the leakage current expressed by “I” is reliably prevented, resulting in prevention of beat tones.

On the other hand, at areas less prone to beat tones or at areas directly below the low voltage areas 81, the leakage current is small in amount, and therefore the beat tones can be adequately eliminated even though the groove sections 61 have a relatively small depth. When the groove sections 61 thus include areas having a relatively small depth, the strength degradation of the chassis can be prevented, compared to providing groove sections simply having a depth that is equal to the depth thereof at areas directly below the high voltage areas 80. Consequently, the backlight device 12 and therefore the liquid crystal display device 10 can be provided with sufficient strength for use.

In order to provide a technical measure while preventing the strength degradation of the chassis 14, groove sections have been solely provided at areas directly below the high voltage areas 80 of the cold cathode tubes 17, by way of experiment. However, according to the construction, beat tones cannot be adequately reduced, while the strength of the chassis 14 is maintained.

Specifically, in the present preferred embodiment, the depth of each groove section 61 decreases continuously and gradually from the areas directly below the high voltage areas 80 of the cold cathode tube 17 toward the area directly below the low voltage area 81.

Due to the construction thus having continuously and gradually decreasing depth, beat tones can be effectively eliminated. The high voltage side is prone to beat tones due to current leakage from the light source. However, the leakage current decreases substantially continuously toward the low voltage side. For this reason, the groove sections 61 preferably have a depth continuously decreasing from the areas directly below the high voltage areas 80 toward the areas directly below the low voltage areas 81, which can be an effective measure to prevent leakage current and thereby suppress beat tones.

Thus, the backlight device 12, and therefore the liquid crystal display device 10 including the backlight device, has a simple construction including groove sections 61 having a larger depth at areas directly below the high voltage areas 80 of the cold cathode tubes 17 than at areas directly below the low voltage areas 81, which can prevent or minimize beat tones while the sufficient strength of the chassis 14 is maintained.

Shown above is the preferred embodiment 2 of the present invention. However, the present invention is not limited to the preferred embodiment explained in the above description made with reference to the drawings. The following preferred embodiments may be included in the technical scope of the present invention, for example.

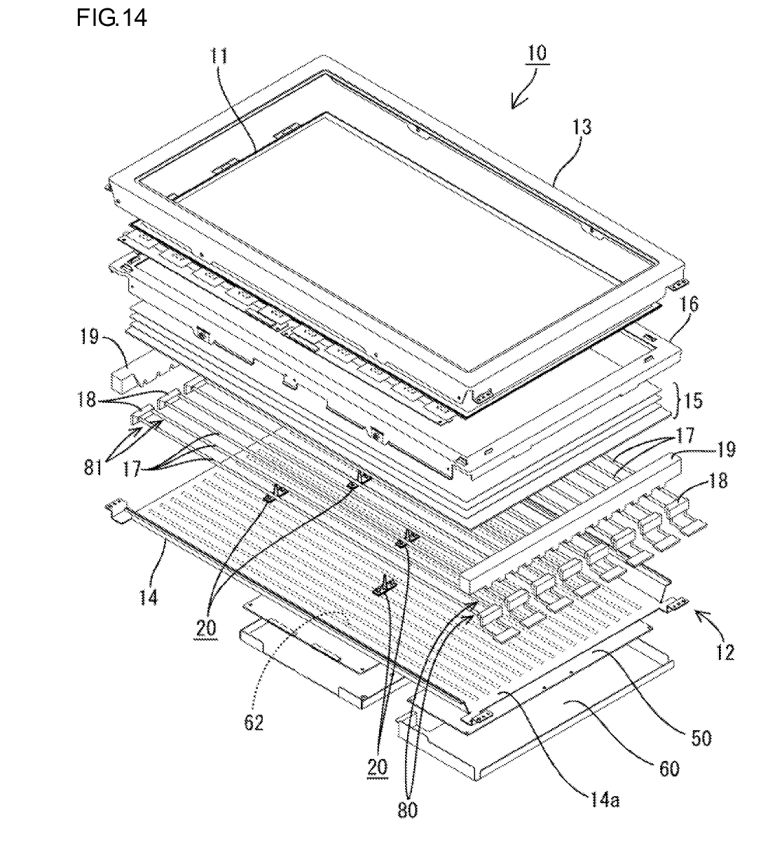

In the above preferred embodiment 2, the inverter boards 30 are preferably arranged at two ends of the backlight chassis 14, so that inverter circuits are connected to both end portions of each cold cathode tube 17. However, referring to FIG. 14, an inverter board 30 may be provided at one end of the backlight chassis 14. That is, an inverter circuit may be connected to one end portion of each cold cathode tube 17. In this case, the one end portion of each cold cathode tube 17 is subjected to high voltage during lighting.

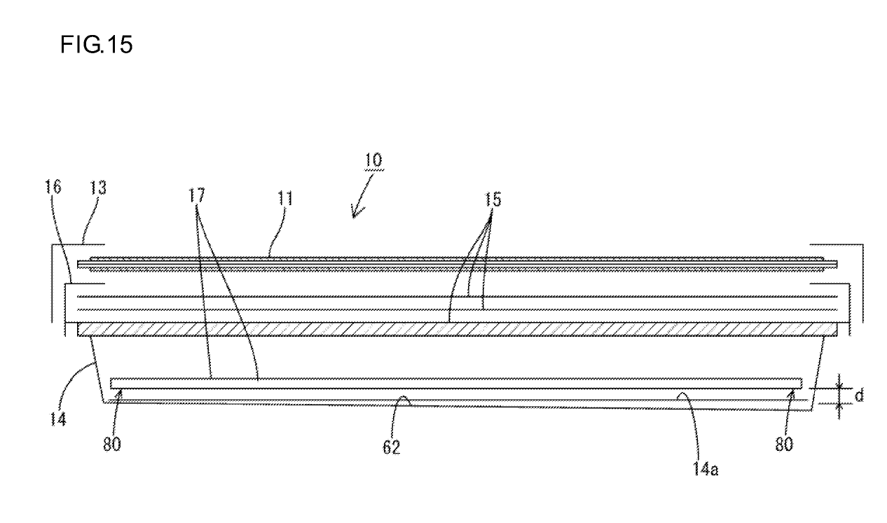

In the construction, referring to FIG. 15, groove sections 62 can be provided to have a larger depth at an area directly below the end portion of each cold cathode tube 17 that is connected to the inverter circuit. Preferably, the depth thereof may be set to decrease continuously and gradually toward an area directly below the other end portion of each cold cathode tube 17.

In the above preferred embodiment 2, each cold cathode tube 17 has a linear shape. However, substantially U-shaped cold cathode tubes may be used, instead.

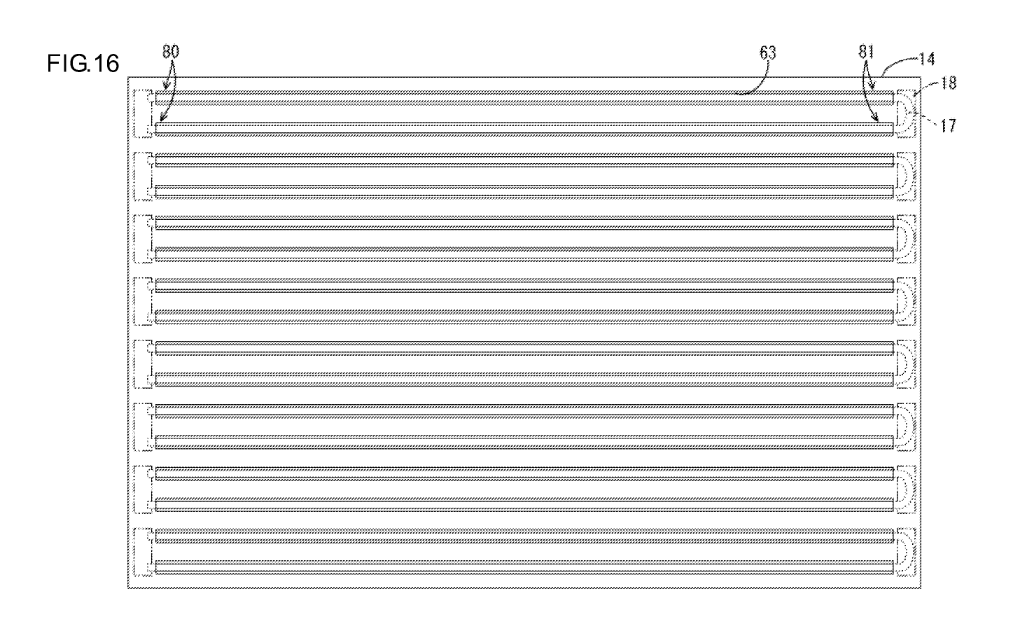

In this case, groove sections 63 can be provided to have a larger depth at areas directly below two end portions of each cold cathode tube 17, which are connected to an inverter circuit and therefore are to be subjected to high voltage. Preferably, the depth thereof may be set to decrease continuously and gradually along the linear portions of the cold cathode tube 17. According to the construction, groove sections 63 are not provided at areas directly below the bent portions of the cold cathode tubes 17, as shown in FIG. 16. However, the absence of groove sections 63 will not cause failure in elimination of beat tones, because the bent portions are to be subjected to significantly low voltage.

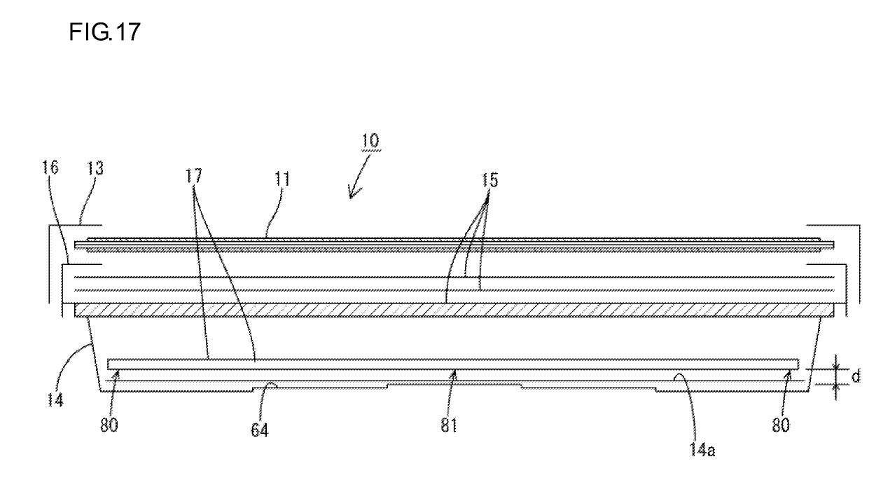

In the above preferred embodiment 2, the groove sections 61 preferably have a depth that decreases continuously and gradually from areas directly below the high voltage areas 80 of the cold cathode tubes 17 toward areas directly below the low voltage areas 81. However, groove sections 64 may preferably have a depth that decreases step-by-step and gradually from areas directly below the high voltage areas 80 of the cold cathode tubes 17 toward areas directly below the low voltage areas 81, as shown in FIG. 17.

The present construction enables elimination of beat tones while minimizing the strength degradation of the chassis 14, due to the following reasons. At the high voltage areas 80 of the cold cathode tubes 17 or areas prone to beat tones, the distance between the chassis 14 and the cold cathode tubes 17 should be set to be large, i.e., the groove sections 64 should be set to be large in depth. In contrast, at the low voltage areas 81 of the cold cathode tubes 17 or areas less prone to beat tones, the groove sections 64 are sufficiently effective even if the depth thereof is set to be small. The depth can be thus varied appropriately depending on the respective areas. Thereby, the integral of the depth of groove sections 64 (i.e., the extent of concavity or convexity of the bottom surface of the chassis 14) is minimized, and accordingly the strength degradation of the chassis 14 is minimized. Consequently, the backlight device 12 and therefore the liquid crystal display device 10 can be provided with sufficient strength for use.

In the above preferred embodiment 2, the cross-sectional shape of each groove section 61 along its short axis is preferably a quadrangle, for example (See FIG. 10). However, the cross-sectional shape is not limited to the quadrangle, but rather may be another shape such as a triangular or other polygonal shape or semicircular shape, for example.

### Preferred Embodiment 3

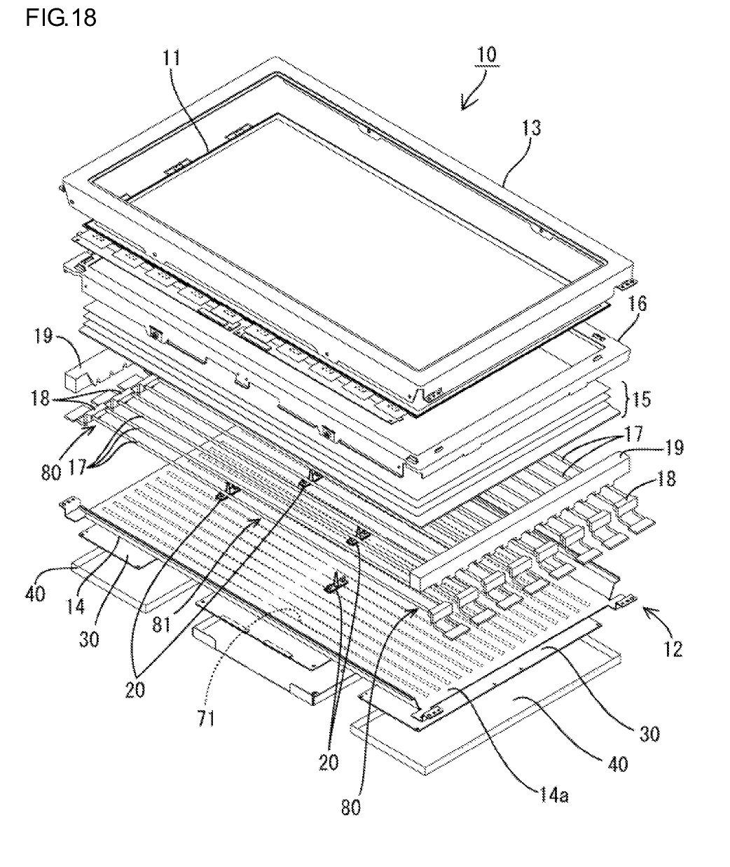

Next, the preferred embodiment 3 of the present invention will be explained with reference to FIGS. 18 to 21. The difference from the above preferred embodiments 1 and 2 is that groove sections having continuously varying depth and width are provided as the distance providing mechanism. The other constructions are similar to the above preferred embodiments. Therefore, the same elements as the above preferred embodiments are designated by the same symbols, and redundant explanations are omitted.

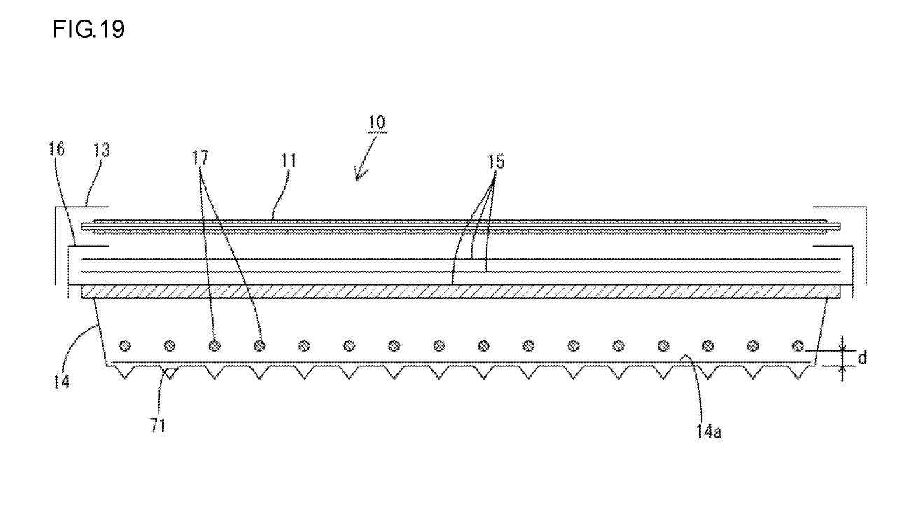

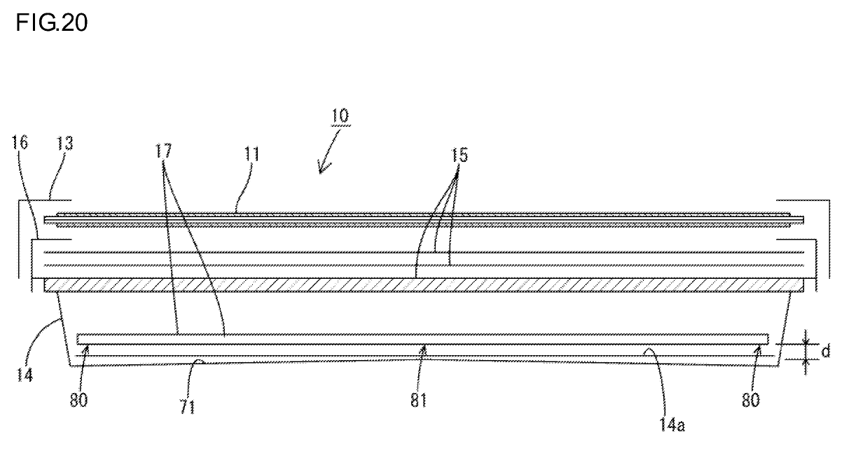

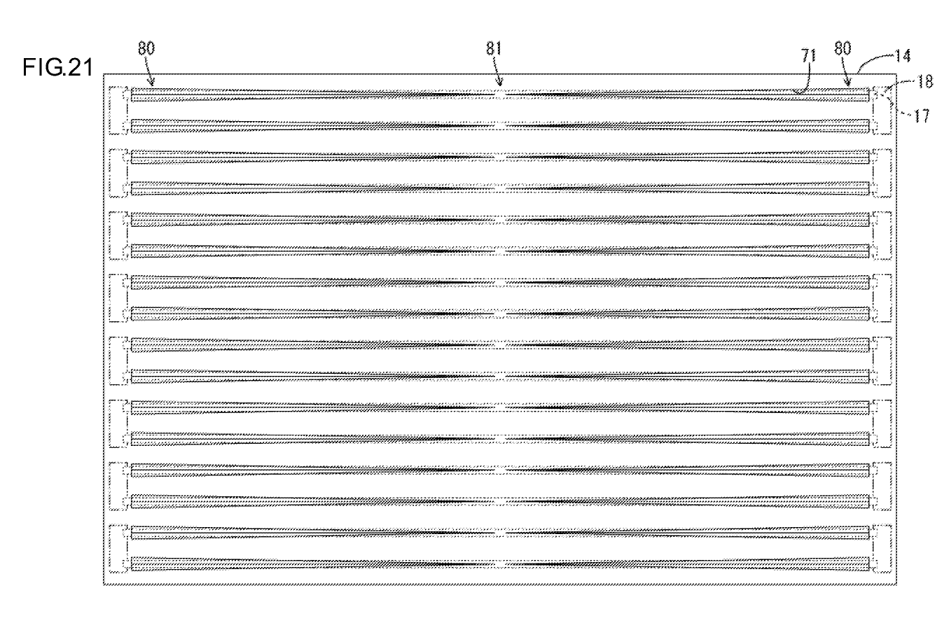

FIG. 18 is an exploded perspective view showing the general construction of a liquid crystal display device according to the present preferred embodiment. FIG. 19 is a sectional view showing the general construction of the liquid crystal display device along the line A-A. FIG. 20 is a sectional view showing the general construction of the liquid crystal display device along the line B-B. FIG. 21 is a plan view showing the general construction of a backlight chassis (chassis).

Each cold cathode tube 17 preferably has an elongated tubular shape (or a linear shape), and inverter circuits are connected to both end portions thereof (See FIG. 18). Therefore, the both end sides of each cold cathode tube 17 are provided as high voltage areas 80, while the central area is provided as a low voltage area 81. Referring to FIG. 28, in the present preferred embodiment, the cold cathode tubes 17 are driven by pulse-width modulation (PWM), for example. Thereby, the dimming control is performed in a predetermined cycle.

On the other hand, on the bottom surface of the backlight chassis 14 arranged parallel to the cold cathode tubes 17, the groove sections 71 (or distance providing mechanism) are provided to be located directly below the parallel-arranged cold cathode tubes 17. Referring to FIG. 21, each groove section 71 is arranged along the axial direction of a cold cathode tube 17, and includes a pair of elongated substantially-isosceles triangular sections, which are arranged so that the vertices of isosceles triangles between two sides of equal length face each other. That is, the width of the groove section 71 decreases continuously and gradually from the end areas (or high voltage areas 80) of the cold cathode tube 17 toward the central area (or low voltage area 81).

Referring to FIG. 20, each groove section 71 is provided to have a depth that decreases continuously and gradually from the end areas (or high voltage areas 80) of a cold cathode tube 17 toward the central area (or low voltage area 81).

The groove sections 71 are formed by partially concaving the backlight chassis 14, so as to bulge from the backlight chassis 14 toward the opposite side of the opening side of the groove sections (i.e., toward the opposite side of the light emitting surface) (See. FIG. 19). Each groove section 71 has a ridge-like bottom so as to have a substantially-isosceles triangular cross-section.

The groove sections 71 are provided on the inner side of a light reflecting sheet 14a, and therefore are shown by broken lines in FIG. 18. The groove sections 71 are made during the sheet processing of the backlight chassis 14, in the present preferred embodiment.

The liquid crystal display device 10 thus constructed according to the present preferred embodiment can provide the following operational effects.

In the liquid crystal display device 10 of the present preferred embodiment, the chassis (backlight chassis) 14 of the backlight device 12 preferably includes groove sections 71 (or distance providing mechanism) located directly below the cold cathode tubes 17. The groove sections 71 have relatively large depth and width at areas directly below the high voltage areas 80 of the cold cathode tubes 17, and have relatively small depth and width at areas directly below the low voltage areas 81. According to the construction, while the strength of the chassis 14 is maintained, the chassis 14 is less likely to generate beat tones, which can be caused by its vibration.

The groove sections 71 are thus provided to have relatively large depth and width at areas directly below the high voltage areas 80 of the cold cathode tubes 17, according to the present preferred embodiment. In the construction, “d” (distance between the cold cathode tubes 17 and the chassis 14) can be large because of the large depth of the groove sections 71, and areas where “d” (distance between the cold cathode tubes 17 and the chassis 14) is large can be provided to be large in size because of the large width of the groove sections 71, referring to the following formula (1):

I=2πfεCV=2πfε(S/d)V formula (1)

where “I” is the amount of leakage current, “C” is the stray capacitance, “V” is the potential difference between the cold cathode tubes 17 and the chassis 14, “S” is the area of the chassis 14, and “d” is the distance between the cold cathode tubes 17 and the chassis 14.

Consequently, the leakage current expressed by “I” is reliably prevented, resulting in prevention of beat tones.

On the other hand, the groove sections 71 are provided to have relatively small depth and width at areas directly below the low voltage areas 81 of the cold cathode tubes 17. At areas directly below the low voltage areas 81, the leakage current is originally small in amount, and therefore the beat tones can be adequately eliminated even though the groove sections 71 have small depth and width. When the groove sections 71 thus include areas having relatively small depth and width, the strength degradation of the chassis can be prevented, compared to providing groove sections simply having depth and width which are equal to the depth and width thereof at areas directly below the high voltage areas 80. Consequently, the backlight device 12 and therefore the liquid crystal display device 10 can be provided with sufficient strength for use.

Specifically, in the present preferred embodiment, the depth and width of each groove section 71 decrease continuously and gradually from the areas directly below the high voltage areas 80 of the cold cathode tube 17 toward the area directly below the low voltage area 81.

The high voltage side is prone to beat tones due to current leakage from the light source. However, the leakage current decreases substantially continuously toward the low voltage side. For this reason, the groove sections 71 are provided to have depth and width continuously decreasing from the areas directly below the high voltage areas 80 toward the areas directly below the low voltage areas 81, which can be an effective measure to prevent leakage current and thereby prevent beat tones.

Shown above is the preferred embodiment 3 of the present invention. However, the present invention is not limited to the preferred embodiment explained in the above description made with reference to the drawings. The following preferred embodiments may be included in the technical scope of the present invention, for example.

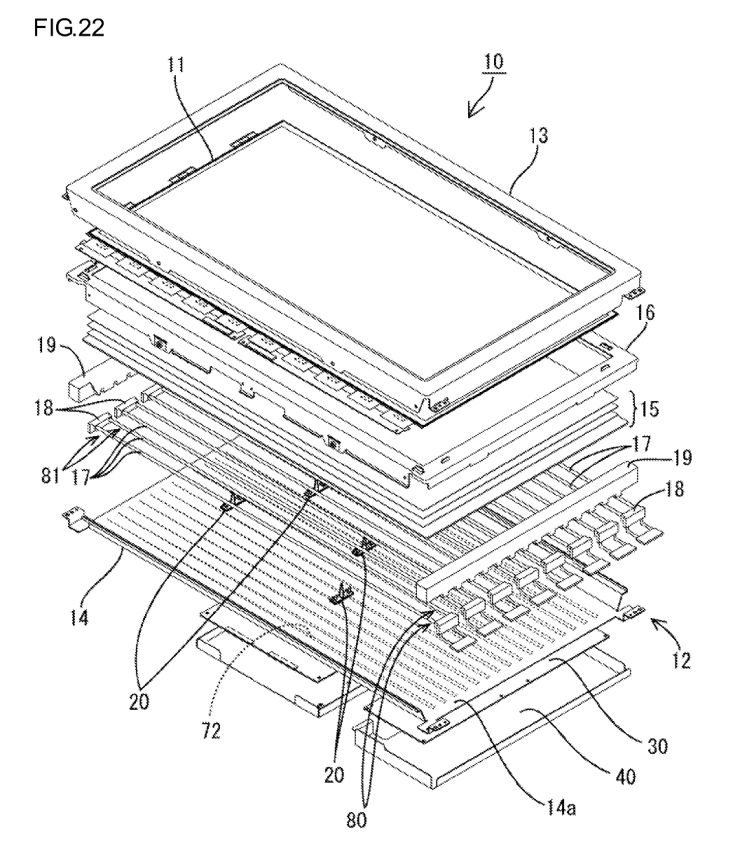

In the above preferred embodiment 3, the inverter boards 30 are preferably arranged at two ends of the backlight chassis 14, so that inverter circuits are connected to both end portions of each cold cathode tube 17. However, referring to FIG. 22, an inverter board 30 may be provided at one end of the backlight chassis 14. That is, an inverter circuit may be connected to one end portion of each cold cathode tube 17. In this case, the one end portion of each cold cathode tube 17 is subjected to high voltage during lighting.

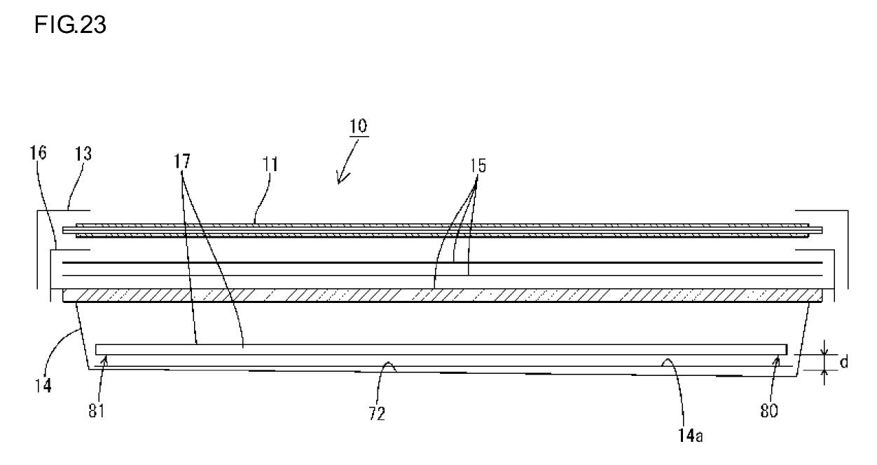

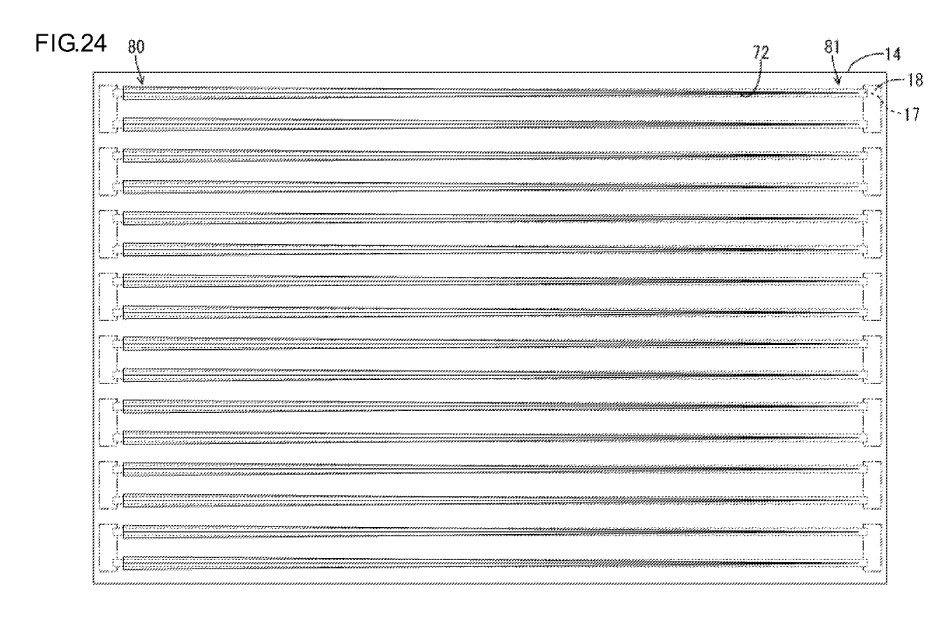

In the construction, referring to FIGS. 23 and 24, groove sections 72 can be provided to have larger depth and width at an area directly below the end portion of each cold cathode tube 17 that is connected to the inverter circuit. Preferably, the depth and width thereof may be set to decrease continuously and gradually toward an area directly below the other end portion of each cold cathode tube 17.

In the above preferred embodiment 3, each cold cathode tube 17 preferably has a linear shape. However, substantially U-shaped cold cathode tubes, for example, may be used, instead.

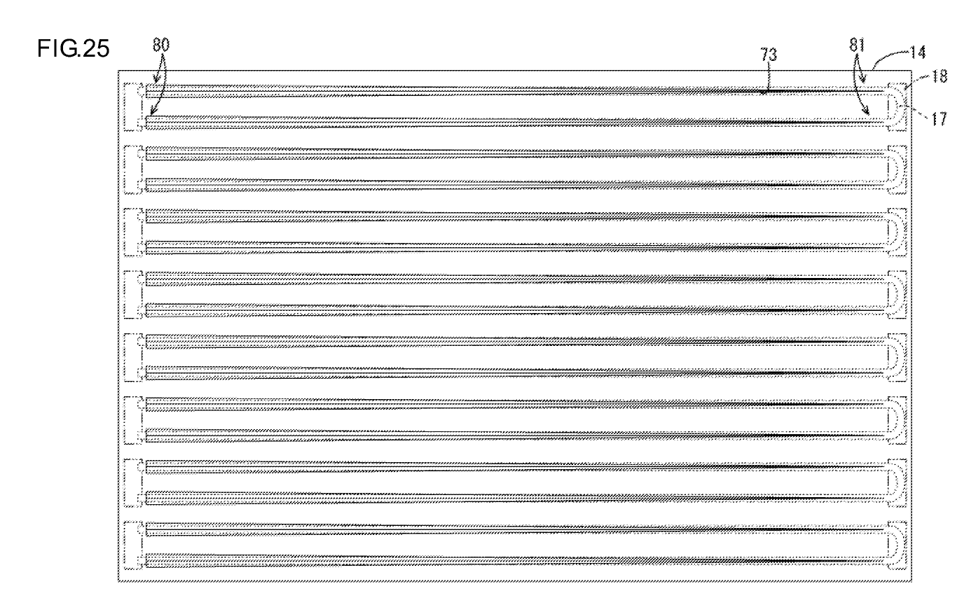

In this case, groove sections 73 can be provided to have larger depth and width at areas directly below two end portions of each cold cathode tube 17, which are connected to an inverter circuit and therefore are to be subjected to high voltage. Preferably, the depth and width thereof may be set to decrease continuously and gradually along the linear portions of the cold cathode tube 17. According to the construction, groove sections 73 are not provided at areas directly below the bent portions of the cold cathode tubes 17, as shown in FIG. 25. However, the absence of groove sections 73 will not cause failure in elimination of beat tones, because the bent portions are to be subjected to significantly low voltage.

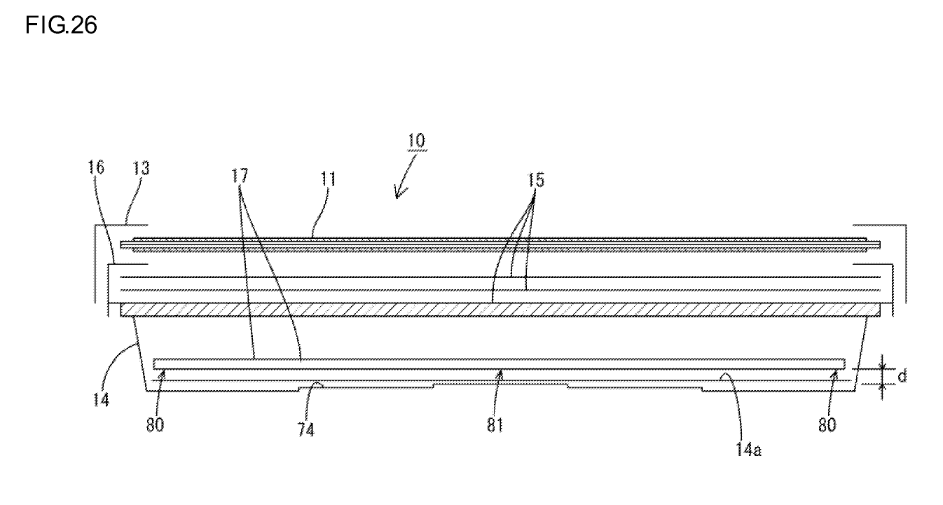

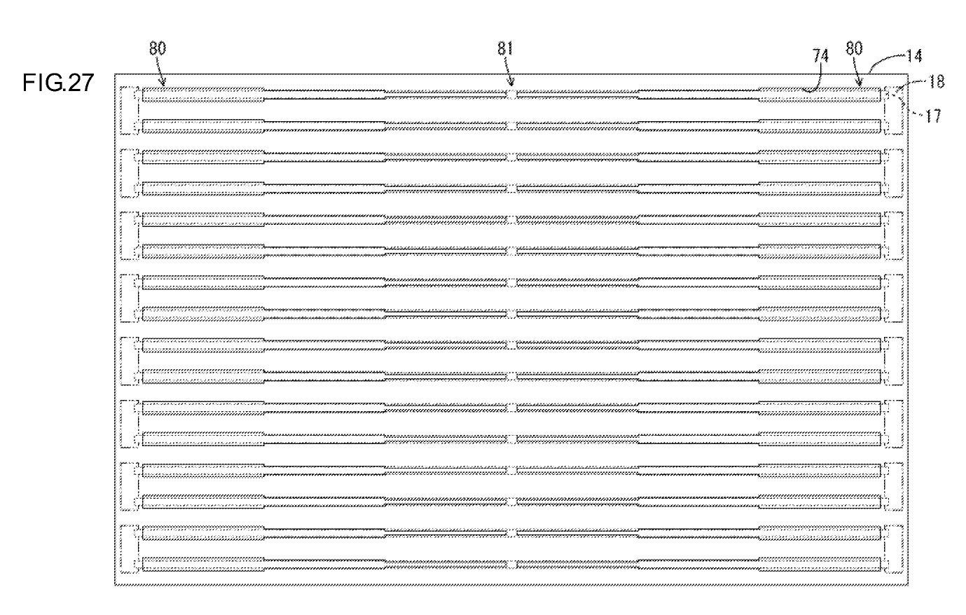

In the above preferred embodiment 3, the groove sections 71 are provided to have depth and width decreasing continuously and gradually from areas directly below the high voltage areas 80 of the cold cathode tubes 17 toward areas directly below the low voltage areas 81. However, groove sections 74 may be provided to have depth and width decreasing step-by-step and gradually from areas directly below the high voltage areas 80 of the cold cathode tubes 17 toward areas directly below the low voltage areas 81, as shown in FIGS. 26 and 27.

The present construction enables elimination of beat tones while minimizing the strength degradation of the chassis 14, due to the following reasons. At the high voltage areas 80 of the cold cathode tubes 17, the distance between the chassis 14 and the cold cathode tubes 17 is preferably large, and areas where the distance is thus large are preferably large. That is, the groove sections 74 are preferably large in depth and width, in order to eliminate beat tones. In contrast, at the low voltage areas 81 of the cold cathode tubes 17, the groove sections 74 are sufficiently effective even if the depth and width thereof are relatively small. The depth and width can be thus varied appropriately depending on the respective areas. Thereby, the integral of the depth of groove sections 74 (i.e., the extent of concavity or convexity of the bottom surface of the chassis 14) is minimized, and accordingly the strength degradation of the chassis 14 is minimized. Consequently, the backlight device 12 and therefore the liquid crystal display device 10 can be provided with sufficient strength for use.

In the above preferred embodiment 3, the cross-sectional shape of each groove section 71 along its short axis preferably is a triangle (See FIG. 19). However, the cross-sectional shape is not limited to the triangle, but rather may be another shape such as another polygonal shape or semicircular shape, for example.

### Other Preferred Embodiments

Described above are the preferred embodiments 1, 2 and 3 of the present invention. However, the present invention is not limited to the preferred embodiments explained in the above description made with reference to the drawings. The following preferred embodiments may be included in the technical scope of the present invention, for example.

The inclined surfaces are preferably arranged to extend over the entire chassis in the above preferred embodiment 1, while the groove sections are provided on the chassis in the preferred embodiments 2 and 3. However, the present invention can also include a preferred embodiment in which inclined surfaces and groove sections are used in combination.

In the above preferred embodiments 1, 2 and 3, cold cathode tubes 17 are preferably used as light sources, for example. However, the present invention can also include a construction in which another type of light sources such as hot cathode tubes is used, for example.

In the above preferred embodiments 1, 2 and 3, TFTs are preferably used as switching elements of the liquid crystal display device, for example. However, the present invention can be applied to a liquid crystal display device that uses another type of switching elements than TFTs (e.g., thin-film diodes (TFDs)). Further, the present invention can be applied to a liquid crystal display device for monochrome display, as well as a liquid crystal display device capable of color display.

Moreover, although a liquid crystal display device is shown in the above preferred embodiments 1, 2 and 3, the present invention can be applied to other types of display devices than a liquid crystal type, which use a backlight device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-13. (canceled)

14. A lighting device for a display device, comprising:
a light source; and
a chassis arranged to cover said light source; wherein
said light source includes a high voltage area to be subjected to relatively high voltage, and a low voltage area to be subjected to relatively low voltage; and
said chassis includes a distance providing mechanism arranged to provide a vertical distance between said chassis and said light source so that the vertical distance is relatively large at the high voltage area of said light source and relatively small at the low voltage area of said light source.

15. A lighting device for a display device, as in claim 14, wherein said distance providing mechanism includes one of an incline and a stepped area that extends over an entire bottom surface of said chassis.

16. A lighting device for a display device, as in claim 14, wherein:
said distance providing mechanism includes a groove section provided directly below said light source; and
said groove section has a depth that is relatively large at an area directly below the high voltage area of said light source and a depth that is relatively small at an area directly below the low voltage area of said light source.

17. A lighting device for a display device, as in claim 16, wherein said groove section has a width that is relatively large at an area directly below the high voltage area of said light source and a width that is relatively small at an area directly below the low voltage area of said light source.

18. A lighting device for a display device, as in claim 17, wherein said groove section has a width that decreases continuously and gradually from the area directly below the high voltage area of said light source toward the area directly below the low voltage area.

19. A lighting device for a display device, as in claim 17, wherein said groove section has a width that decreases step-by-step and gradually from the area directly below the high voltage area of said light source toward the area directly below the low voltage area.

20. A lighting device for a display device, as in claim 16, wherein:
said light source has a linear shape; and
said groove section is arranged to extend along the linear shape of said light source.

21. A lighting device for a display device, as in claim 14, wherein said distance providing mechanism is arranged to decrease the vertical distance between said chassis and said light source, continuously and gradually from the high voltage area of said light source toward the low voltage area.

22. A lighting device for a display device, as in claim 14, wherein said distance providing mechanism is arranged to decrease the vertical distance between said chassis and said light source, step-by-step and gradually from the high voltage area of said light source toward the low voltage area.

23. A lighting device for a display device, as in claim 14, wherein said light source is arranged to be driven by pulse-width modulation.

24. A lighting device for a display device, as in claim 14, wherein said chassis includes a metallic plate.

25. A display device comprising:
a lighting device for a display device, as in claim 14; and
a display panel arranged to perform display by use of light from said lighting device for a display device.

26. A display device as in claim 25, wherein said display panel is a liquid crystal panel including liquid crystal material.
